(19) United States
(12) Patent Application Publication
(10) Pub. No.: US 2004/0164565 A1
(43) Pub. Date: Aug. 26, 2004

(54) Door strike and method therefor

(76) Inventors: Bill Wagner, Fountain Hills, AZ (US); Neil Jarvey, Tempe, AZ (US)

Correspondence Address: WEISS & MOY PC, 4204 NORTH BROWN AVENUE, SCOTTSDALE, AZ, 85251, US

(21) Appl. No.: 10/375,816

(22) Filed: Feb. 26, 2003

(51) Int. Cl. E05B 15/02

(52) U.S. Cl. 292/340

(57) ABSTRACT

An improved door strike has an elongated metal plate member which is coupled to a doorframe. A lip member is formed on the side of the elongated metal plate for protecting the doorframe from damage. An opening is located in a central area of the elongated metal plate for receiving a door latch bolt. Apertures are located above and below the opening for coupling the improved door strike to the doorframe.

### FIELD OF THE INVENTION

This invention relates to locking mechanisms and, more specifically, to an improved door strike which will prevent a locking mechanism from damaging the door frame and which will allow the door latch bolt to more easily fit and slide into the improved door strike.

### BACKGROUND OF THE INVENTION

The typical doorknob assembly consists of opposing doorknobs secured to the edge of a door through a cutout in the door. A bore is drilled from the front edge of the door to the cutout. The bore in the door defines a path along which the door latch bolt travels. Another bore is drilled on the doorframe where the door latch bolt engages the doorframe. The bore on the doorframe is generally covered by a door strike. When the door is closed, the door latch bolt will hit the door strike and slide into a bore drilled in the doorframe. This will secure the door in a closed position.

Present door strikes are made of metal and basically just cover the bore drilled in the doorframe. While present door strikes do work, there are several problems associated with them. First, most door strikes do not protect the edges of the doorframe. When a door is closed, many times the door latch bolt will strike the doorframe prior to engaging the door strike. When the door latch bolt strikes the doorframe, the door latch bolt has a tendency to scuff and damage the doorframe. Second, may times when installing a door lock, there is a tendency to misalign the bore drilled in the front edge of the door and the bore drilled on the door frame. Even a slight misalignment will cause difficulty when trying to close a door. This is due to the fact that there is very little difference in the size of the opening in the door strike and the size of the door latch bolt. Thus, a small misalignment will cause difficulty when the door latch bolt tries to settle in the opening in the door strike. Third, most door strikes are small and only cover the bore drilled in the doorframe. Thus, the door strikes, after extended usage, have a tendency to break away from the doorframe.

Therefore a need existed to provide an improved door strike. The improved door strike will protect the edges of the doorframe from damage caused by the door latch bolt. The improved door strike will allow for the door latch bolt to more easily fit within the opening in the door strike. The improved door strike will guide the door latch bolt into the opening in the door strike. The improved door strike will further be more securely affixed to the doorframe.

### SUMMARY OF THE INVENTION

In accordance with one embodiment of the present invention, it is an object of the present invention to provide an improved door strike that will protect the edges of the doorframe from damage caused by the door latch bolt.

It is another object of the present invention to provide an improved door strike that will allow for the door latch bolt to more easily fit within the opening in the door strike.

It is still another object of the present invention to provide an improved door strike that will guide the door latch bolt into the opening in the door strike.

It is still another object of the present invention to provide an improved door strike that will be more securely affixed to the doorframe.

### BRIEF SUMMARY OF THE INVENTION

In accordance with one embodiment of the present invention, an improved door strike is disclosed. The improved door strike has an elongated metal plate member which is coupled to a doorframe. A lip member is formed on the side of the elongated metal plate for protecting the doorframe from damage. An opening is located in a central area of the elongated metal plate for receiving a door latch bolt. Apertures are located above and below the opening for coupling the improved door strike to the doorframe.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is an elevated perspective view of the door strike of the present invention installed on a doorframe.

FIG. 2 is a cross-sectional top view of the door strike depicted in FIG. 1 with a door latch bolt engaging the door strike.

FIG. 3 is a front view of the door strike depicted in FIG. 1

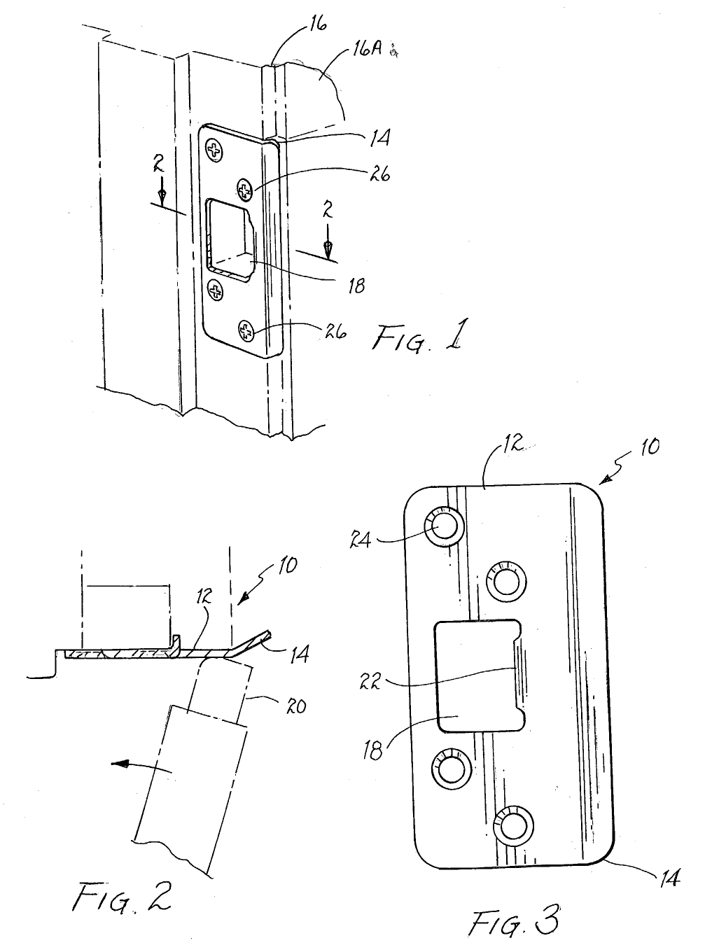

### DETAILED DESCRIPTION

Referring to the Figures, an improved door strike 10 (hereinafter door strike 10) is shown. The door strike 10 has several advantages over prior art door strikes. The door strike 10 is designed to protect the edges of the door frame 16 as well as the door casing 16A from damage caused by the door latch bolt 20. The door strike 10 is designed to allow for the door latch bolt 20 to more easily fit within the opening 18 in the door strike 10. The door strike 10 will guide the door latch bolt 20 into the opening 18 in the door strike 10. The door strike 10 will further allow the door strike 10 to be more securely affixed to the doorframe 16. Thereby enhancing security.

The door strike 10 is made of a plate 12. The plate 12 is generally made out of a metal material. Any metal material may be used. In general, to be more aesthetically pleasing, many people would prefer to have the door strike 10 made from a metal that will match the type of metal used on the door knobs.

The door strike 10 will have a lip member 14. The lip member 14 will run along the entire length of the door strike 10. The lip member 14 is formed at an angle. The lip member 14 will angle behind the plate 12. When door strike 10 is installed on a doorframe 16, the lip member 14 will cover and protect the edge of a doorframe 16 and the door casing 16A where the door strike 10 is installed. When a door is closed, the door latch bolt 20 will hit the lip member 14 instead of the side of the doorframe 16 or door casing 16A. Thus, the lip member 14 will prevent the door latch bolt 20 from damaging the doorframe 16 and door casing 16A.

Located in a central area of the plate 12 is an opening 18. The opening 18 is used to receive the door latch bolt 20. Unlike the prior art, the opening 18 is formed slightly larger than the size of the door latch bolt 20. Thus, even if the door strike 10 is slightly misaligned from the door latch bolt 20, the door latch bolt 20 can still slide within the opening 18.

A guide device 22 is formed on an edge of the opening 18. The guide member 22 is generally an angled tab member formed on the edge of the opening closest to where the door latch bolt 20 will first engage the door strike 10. The guide member 22 is used to help position the door latch bolt 20 within the opening 18. As stated above, if the door strike 10 and the door latch bolt are slightly misaligned, the door latch bolt 20 will have a difficult time entering the opening 18. The guide device 22 will help to guide the door latch bolt 20 into the opening 18.

The plate 12 is slightly longer than the prior art. The size of the plate 12 will allow one to more securely affix the door strike 10 to the doorframe 16. The plate 12 will have an aperture 24 located above the opening 18 and an aperture 24 located below the opening 18. In general, a pair of apertures 24 is formed above and below the opening 18. The apertures 24 are used to secure the door strike 10 to the doorframe 16. In accordance with one embodiment of the present invention, each pair of apertures 24 is arranged in an offset manner. Thus, one aperture 24 would be formed at an angle away from the other aperture 24. If the apertures 24 are formed directly below one another, the door strike 10 will not be as securely fastened to the doorframe 16 and will have a tendency to bend and pull away from the doorframe 16. By angling the apertures 24, both sides of the plate 12 will be securely fastened to the doorframe 16. In general, some type of wood screw 26 is inserted into the apertures to secure the door strike 10 to the doorframe 16. In accordance with one embodiment of the present invention, three inch screws are used to secure the plate 12 to the doorframe 16. The extended length of the screws 26 will provided a security feature since it will be exceeding difficult to pry the plate 12 from the doorframe 16.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. An improved door strike comprising:
an elongated metal plate member coupled to a doorframe;
a lip member formed on the side of the elongated metal plate for protecting the doorframe from damage;
an opening located in a central area of the elongated metal plate for receiving a door latch bolt; and
apertures located above and below the opening for coupling the improved door strike to the doorframe.

2. An improved door strike in accordance with claim 1 wherein the lip member extends along an entire length of the elongated metal plate.

3. An improved door strike in accordance with claim 1 wherein the opening is slightly larger than the size of the door latch bolt to ensure that the door latch bolt will fit within the opening even when the improved door strike is slightly misaligned from the door latch bolt.

4. An improved door strike in accordance with claim 1 wherein the apertures comprises a pair of apertures located above and below the opening.

5. An improved door strike in accordance with claim 4 where the pair of apertures comprises:
a first aperture; and
a second aperture wherein the second aperture is located below the first aperture and offset at an angle from the first aperture.

6. An improved door strike in accordance with claim 1 further comprising an alignment tab formed on an edge of the opening for aligning the door latch bolt within the opening.

7. An improved door strike comprising:
an elongated metal plate member coupled to a doorframe;
a lip member formed on the side of the elongated metal plate which extends along an entire length of the elongated metal plate for protecting the doorframe from damage;
an opening located in a central area of the elongated metal plate for receiving a door latch bolt wherein the opening is slightly larger than the size of the door latch bolt to ensure that the door latch bolt will fit within the opening when the improved door strike is slightly misaligned from the door latch bolt;
an alignment tab formed on an edge of the opening for aligning the door latch bolt within the opening; and
apertures located above and below the opening for coupling the improved door strike to the doorframe.

8. An improved door strike in accordance with claim 7 wherein the apertures comprises a pair of apertures located above and below the opening.

9. An improved door strike in accordance with claim 8 where the pair of apertures comprises:
a first aperture; and
a second aperture wherein the second aperture is located below the first aperture and offset at an angle from the first aperture.

10. A method of providing an improved door strike comprising:
providing an elongated metal plate member coupled to a door frame;
providing a lip member formed on the side of the elongated metal plate for protecting the doorframe from damage;
providing an opening located in a central area of the elongated metal plate for receiving a door latch bolt; and
providing apertures located above and below the opening for coupling the improved door strike to the doorframe.

11. The method of claim 10 wherein the step of providing a lip member further comprises providing a lip member which extends along an entire length of the elongated metal plate.

12. The method of claim 10 wherein the step of providing an opening further comprises the step of providing an opening which is slightly larger than the size of the door latch bolt to ensure that the door latch bolt will fit within the opening even when the improved door strike is slightly misaligned from the door latch bolt.

13. The method of claim 10 wherein the step of providing apertures further comprises the step of providing a pair of apertures located above and below the opening.

14. The method of claim 13 where the step of providing a pair of apertures further comprises:
providing a first aperture; and
providing a second aperture wherein the second aperture is located below the first aperture and offset at an angle from the first aperture.

15. The method of claim 10 further comprising the step of providing an alignment tab formed on an edge of the opening for aligning the door latch bolt within the opening.
